(19) United States
(12) Patent Application Publication
(10) Pub. No.: US 2007/0243296 A1
(43) Pub. Date: Oct. 18, 2007

(54) THERAPEUTIC SUPPLEMENT USING UME FRUIT

(76) Inventors: Anuschka M. Bourassa, Lake Geneva, WI (US); Gary G. Bourassa, Lake Geneva, WI (US)

Correspondence Address: Intellectual Property Department;DEWITT ROSS & STEVENS S.C., US Bank Building, 8000 Excelsior Drive, Suite 401, Madison, WI, 53717-1914, US

(21) Appl. No.: 11/687,636

(22) Filed: Mar. 17, 2007

Related U.S. Application Data
(60) Provisional application No. 60/783,650, filed on Mar. 17, 2006.

(51) Int. Cl. A23L 1/36

(52) U.S. Cl. 426/484

(57) ABSTRACT

A therapeutic supplement utilizes a processed form of the Ume fruit in the absence of the Ume seed. In a preferred form, the Ume fruit is processed to achieve a higher alkalinity to increase its therapeutic effectiveness.

### CROSS-REFERENCE TO RELATED APPLICATION

This application claims priority under 35 U.S.C. §119(e) to U.S. Provisional Patent Application 60/783,650 filed Mar. 17, 2006, the entirety of which is incorporated by reference herein.

### FIELD OF THE INVENTION

The present invention relates generally to a method and composition for using a processed Ume fruit, which has had the seeds removed, for the prevention and/or treatment of certain medical conditions including hiccups and acid indigestion in animals, including mammals and humans.

### DESCRIPTION OF THE PRIOR ART

Over the past thirty years or so, the human diet in most advanced countries has become quite acidic in nature. The onset of fast food restaurants, the prevalence of over-processed foods and an over indulgence in the wrong combinations of foods have each played a significant part in creating an incredibly unbalanced and decisively acidic diet.

Acid indigestion is more prevalent today than it has ever been in the past. For the most part, acid indigestion is caused by an excessive intake of acidic or acid forming foods. The human body seeks a particular balance between an acid and an alkaline condition. This unique balance prevents chronic disease and reduces aging caused by the acidification of the blood and other human organs. Healthy human-arterial blood pH varies between 7.35 and 7.45. It is quite common that a sick person's blood will be slightly more acidic. Even a 0.05 increase in blood acidity (a pH of 7.30) can cause human organs and tissue to become inflamed.

Although hiccups have been around for centuries, the root cause of hiccups, along with the absence of a suitable and effective remedy, has been a subject of interest and debate for many years. There are certain medical conditions that can cause chronic bouts of hiccups, but for the most part common hiccups can be directly attributed to an individual's most recently consumed food or drink. In the case of a common hiccup spasm, the diaphragm has become too loose, which is the source of the spasm. When this situation does occur, an alkaline forming food is the best solution and normally will bring the diaphragm back to its original tightness. Unfortunately, few occurrences of hiccups take place where there is an immediate availability of an alkaline forming food. Human lore and traditions have suggested an assortment of remedies, but none has proven to be instantly effective or convenient. A safe and effective over-the-counter remedy for hiccups currently does not exist.

Acid indigestion and the conditions commonly referred to as heartburn, sour stomach and upset stomach have been a growing phenomena for many years. A number of prescription medicines and over-the-counter remedies has been designed and are available today to counteract the symptoms of acid indigestion and its variations. Unfortunately, it would seem that none of the existing medicines or remedies was developed to solve the root cause of the acidic condition or the resultant acid indigestion and its variants. Most of these products were designed to mask the symptoms of acid indigestion, while others to turn off, reduce or otherwise prevent normal digestive functions. Of particular concern for those suffering with acid indigestion is the fact that some of these medicines or remedies contain one or more toxic elements in their composition, and all seem to warn of possible adverse side effects. It is for this reason and for the protection of the consumer that usage restrictions are prevalent in both dosage size and the duration of use. An effective and safe remedy that is designed to relieve the root cause of acid indigestion, or one of its variations, does not currently exist.

### SUMMARY OF THE INVENTION

The present invention is directed to a method of producing a therapeutic supplement from Ume fruit, in the absence of the Ume seed, wherein the Ume fruit is obtained from the Prunus Mume Sieb, et Zucc., comprising pickling the Ume fruit, removing the seeds from the Ume fruit; macerating the Ume fruit to form a Ume paste; and dehydrating the Ume paste. In addition, the present invention includes carbonizing the dehydrated Ume paste. The present invention is also directed to a therapeutic supplement produced according to this method.

The present invention is also directed to a therapeutic supplement comprising a therapeutically effective amount of processed Ume fruit in the absence of the Ume seed, wherein the Ume fruit is obtained from the Prunus Mume Sieb, et Zucc., in combination with a pharmaceutically-acceptable carrier, wherein the therapeutically effective amount of Ume fruit is effective to treat an animal. The present invention is also directed to a therapeutic supplement, wherein the therapeutically effective amount of Ume fruit in the absence of the Ume seed is effective as an edible disinfectant for applications in food cleansing and as a natural food preservative.

The present invention is also directed to a therapeutic supplement for the relief of acid indigestion or hiccups comprising a therapeutically effective amount of processed Ume fruit in the absence of the Ume seed, wherein the processed Ume fruit is obtained from the Prunus Mume Sieb, et Zucc., in combination with a pharmaceutically-acceptable carrier, wherein the therapeutically effective amount of processed Ume fruit is effective to treat acid indigestion or hiccups in an animal, wherein the processed Ume fruit has a pH level between about 7.0 and 9.0.

The present invention provides a quick absorbing, highly concentrated, alkaline forming formula which provides an immediate balance for the acidic condition that was the cause of the hiccup spasm. The present invention provides immediate or instant hiccup relief as a whole food product and does so safely, without concerns of dosage size or the presence of toxicity or any adverse side-effects.

In addition, the present invention provides a quick absorbing, highly concentrated, alkaline forming formula which provides an immediate balance for the acidic condition that was the cause of the acid indigestion. The present invention is useful to prevent or treat acid indigestion and other digestive ailments such as heartburn, sour stomach, upset stomach, diarrhea, gas, and acid reflux as a whole food product and does so safely, without concerns of dosage size or the presence of toxicity or any adverse side-effects.

Further, the present invention is effective for prevention of or treatment for various ailments and is a medicine or medicinal remedy for blood cleansing, liver cleansing, restoring optimum blood flow, reducing excess cholesterol, increasing vitality and strength, anti-aging, stimulating metabolism to build the immune system and building resistance to disease, and as such has been proven to be effective as a treatment for stomatitis, dysentery, typhoid, hypertension in children, headache pain, common cold, common flu, motion sickness, second degree burns, hangovers, ptomaine poisoning, food poisoning, hemorrhoids, vaginitis, vertigo, anemia, eczema, athlete's foot, halitosis, nasal conditions, colic in infants, lack of appetite, vomiting during pregnancy, as a laxative, an enema, as an edible disinfectant for applications in food cleansing, and as a natural food preservative.

One of the most interesting aspects of this invention is that these attributes have been accomplished from a processed whole food product and therefore is extremely safe to ingest, without concerns of dosage size or the presence of toxicity or any adverse side-effects. Further, the method of the present invention may be administered to animals, including mammals and humans, of all ages and health.

Since the medicine or medicinal remedy is comprised of pickled Ume fruit, it is a natural whole food and therefore will not cause addiction, even when being taken daily, and can be done so without adverse side effects or toxicity and even when taking larger dosages, such as 100 g/time or more. The medicine, medicinal remedy or whole food product of the present invention can be taken daily. Without wishing to be held to one particular theory, it is believed that the medicinal effects can be ascribed to remarkable improvement of the blood flow rate after taking the medicine of the present invention.

The objects and advantages of the invention will appear more fully from the following detailed description of the preferred embodiment of the invention.

### DETAILED DESCRIPTION OF THE INVENTION

Ume:

Ume is the Japanese name for a particular species of Asian plum (Prunus Mume Sieb, et Zucc.) The Ume tree originated from China, but for over 1500 years has also been grown in Korea and Japan. Recently, the Ume tree has begun to be cultivated within the state of California, here in the United States.

There are more than 350 commercial cultivars of the Ume tree in Japan, where it has found to be quite popular, who cultivate the tree for its fruits and/or flowers. The tree flowers in late winter and typically prior to the appearance of any leaves. Each flower has five petals and offers a unique aroma when in bloom. The Ume tree sprouts leaves after the blossoms have fallen. Although the Ume is referred to as a plum, it is actually more closely related to the apricot. In Japan, the fruit begins to ripen in May or June.

The Ume tree belongs to the plum subgenus of the cherry genus of the rose family with a scientific name of Prunus Mume Sieb. et Zucc., is named Mei in Chinese, Japanese Apricot in English, Japanische Aprikose in Germany, and Prunier du Japon in French.

In Asia, Ume trees are cultivated in a number of varieties. In Japan for instance, Ume trees are cultivated in many varieties including 29 varieties of Haku-bai (white-blossomed Ume tree), 25 varieties of Ko-bai (red-blossomed Ume tree), and 6 varieties of Zasshoku (multi-colored Ume tree). Premium examples of Ume varieties include Koshu-Saishou, Ryukyo-Ko-ume, Nankou, Inazumi, Shiro-Kaga, Gyoku-ei, Bungo and O-ume. There are over 350 commercial Ume cultivators in Japan, each producing pickled Umes and/or Ume wine. Many of these cultivators also market the flowers from the Ume tree and some for the trees themselves. Thousands of smaller independent farmers also cultivate Ume and produce pickled Umes and/or Ume wine for personal or localized market consumption. In this invention, the Ume fruit derived from a wide variety of Ume trees, from a wide variety of cultivators and from a number of countries can be used.

The Japanese found a culinary use of the fruit of the Ume tree through the use of a simple pickling process. During the past century, the art of pickling Ume was perfected in Japan and eventually this artful technique was learned and utilized by cultivators in Korea and China as well. The art of pickling Ume fruit typically includes the use of natural sea salt and shiso (perilla) leaves.

Today, the process of pickling Ume, although fairly simple, is followed closely throughout Japan, China and Korea with great care and proficiency. Freshly picked Ume plums are washed and then dried on long rice mats, by exposing them to the sunshine. The Ume plums are even left out over night. During the night and into the next morning, the evening dew works to re-soften the plums. As the sun comes up, the sunshine again dries them, and then at night the process starts again. This process is repeated for several days, sometimes longer, until the fruit has dried. Upon completion of this drying process, the plums become smaller and have a wrinkled appearance.

The dried Ume plums are then packed into specially designed barrels, together with a careful proportioned amount of natural sea salt and the shiso leaves, and then covered by a form fitting top cover and a weight. Through the action of salt, shiso leaves and pressure, the plums begin to shrink, and their juice starts to collect at the bottom of the barrel. During this pickling process, the juices filter to the lower part of the barrel, and the meat of the Ume fruit completes its transformation to a completely pickled Ume fruit.

In this pickled form, Asian culture and lore have found Ume to have some moderate medicinal use beyond its common applications in food and wine. Regarded in the same light as any other ancient herbal remedy, Asian culture has passed on an old tradition of utilizing Ume for a wide range of medicinal purposes. Although effectiveness remains unclear in many cases, the use of Ume has developed a following throughout Asia because of its basic medicinal tendencies.

One attribute of pickled Ume that has stood the test of time beyond the realm of lore, culture and traditions is the fact that Ume is an alkaline forming food and, as such, can provide a basic medicinal benefit.

Processing the Ume:

In this invention, the Ume fruits are for the most part used in whole but without the Ume seeds which are removed and discarded during its conversion to a pickled paste form. The Ume fruit consists of the exodermis, which is the most outer layer or skin of the fruit, the sarcocarp, which is the inner-side or meat of the fruit, and the seed, which is at the center of the sarcocarp. The pickled paste of the exodermis and sarcocarp, as derived from Ume fruits but without the Ume seeds which are removed and discarded during its conversion to a pickled paste form, is used as the raw material for manufacturing the composition of matter of the present invention.

The Ume fruit is pickled and macerated using the method well known to those familiar with the art, after which any unwanted debris, including the seeds, is removed by straining, filtration or other method known to those familiar with the art of making the “Ume paste” which is comprised of the pickled and macerated exodermis and sarcocarp of the Ume fruit. The pickling of the plant material has been known for millennia. The resulting Ume fruit paste is typically packaged, shipped and stored in tubs until needed.

Dehydration:

The Ume fruit paste is then dried. The dehydration process for the Ume fruit paste can be accomplished by a number of different methods known to the art, including rotary drum dehydrators, belt ovens, custom cart ovens, industrial ovens, commercial food dehydrators, and consumer food dehydrators. The heat settings and drying cycle times vary depending on the type of dehydrator used. During the dehydration process, maintaining an average product temperature not to exceed 140° F. (60° C.) is greatly preferred. It has been found that this temperature range effectively maintains the nutrient content while concentrating the medicinal qualities of the product. It is preferred that the moisture content of the dried mixture be no more than about 6% by weight and preferably between about 2% and 4% by weight.

An exemplary and preferred dehydrator is either the Model 3 (69-ft) or Model 5 (109 ft) Refractance Window® dryers (MCD Technologies, Inc., 2515 South Tacoma, Wash. 98409). In this preferred method, a thin layer (approximately 30 to 50 thousands of an inch thick) of pickled Ume fruit paste is spread across a food grade conveyer belt (which is also a heat transfer medium) which floats on top of heated water contained within a heated cistern and travels through the dryer at a belt speed appropriate for the MCD model used. The water temperature is set at an appropriate setting but within a range of between about 200°-210° F. (93.3°-98.9° C.) which, as the heat is transferred through the conveyor belt and into the Ume fruit paste, radiates so as to produce a product temperature no more than about 140° F. (60° C.). Upon completion of the dehydration process, the now dehydrated product exits the conveyer belt as a thin, dehydrated sheet or in the form of flakes or as a combination of both (approximately 10 to 20 thousands of an inch thick). The dehydration process, described herein, noticeably retains the natural taste and color of the product created in the present invention by concentrating the weak medicinal properties contained naturally within Ume fruit paste and concentrating the product's natural alkaline-forming nature to accomplish the desired results.

As the technology used in the art of dehydration is improved, other types of dehydration methods may become available to those familiar with the art of dehydration and therefore will become available to the inventors in the production of the present invention.

Carbonization Process:

The product as derived to this point (or an apportionment thereof) will be carbonized as required for each specific formulation, application or embodiment. The carbonization process for the product of this present invention can be accomplished by a number of different methods, including belt ovens, custom cart ovens, industrial ovens, commercial food ovens, and consumer food ovens. The heat settings and cycle times vary depending on the type of oven used. In some of the present inventions applications and/or embodiments, a particular level of carbonization proved to offer superior results, and therefore a variety of levels of carbonization as invented herein, will be used for those applications and/or embodiments.

Light Carbonization Process: During the light carbonization process, lower oven temperatures, not to exceed about 400° F. (205° C.), are greatly preferred. It is preferred that the resulting carbonization present a medium brown or reddish-brown color, without any signs of black. Although several methods produced the desired result, a preferred method entails baking the dehydrated product of this present invention as it is still formed as a dehydrated sheet or in the form of flakes or as a combination of both. In the most practical method tested, the dehydrated sheets are placed in a preheated oven with the temperature set at 400° F. The dehydrated product of this present invention is baked for no more than 60 minutes or until the entire top of the dehydrated sheet flakes or a combination of both is lightly carbonized to the desired color.

The light carbonization process noticeably intensifies both the potency and the absorption rate of the product and increases the product's (before digestion) pH alkalinity level, from acidic (4.5 to 5.5) to that of a far more neutral level (approximately 7.0 to 7.25). This neutral or slightly alkaline level promotes efficient absorption and assimilation by the body and nutrient conversion, from the very first point of contact within the body. If this first point of contact occurs within the mouth, as in the case of a chewable tablet or a strip, than this improved absorption will occur almost instantaneously. Establishing this more neutralizing level has also proven to enhance or improve potency of the product. As an example, in its application as an acid indigestion product, this more neutral alkalizing state creates a product which quickly influences the acid imbalance occurring within the body and brings the desired relief.

Medium Carbonization Process: During the medium carbonization process, oven temperatures, not to exceed about 500° F. (260° C.), are greatly preferred. It is preferred that the resulting carbonization present a deep brown or deep reddish-brown color, but without any signs of black. Although several methods produced the desired result, a preferred method entails baking the dehydrated product of this present invention as it is still formed as a dehydrated sheet or in the form of flakes or as a combination of both. In the most practical method tested, the dehydrated sheets are placed in a preheated oven with the temperature set at 500° F. The dehydrated product of this present invention is baked for no more than 40 minutes or until the entire top of the dehydrated sheet flakes or a combination of both is more deeply carbonized to the desired color.

The medium carbonization process effectively increases the product's (before digestion) pH alkalinity level, from acidic (4.5 to 5.5) to that of an alkalizing level (7.25 to 8.0). This alkalinity level further promotes efficient absorption and assimilation by the body and nutrient conversion, from first point of contact within the body. If this first point of contact occurs within the mouth, as in the case of a chewable tablet or a strip, then this improved absorption will occur almost instantaneously. Establishing this more alkalizing level has also proven to greatly improve the overall potency and effectiveness of the product. As an example, in its application as an acid indigestion product, this more neutral alkalizing state creates a product which quickly influences the acid imbalance occurring within the body and brings the desired relief. This higher state of alkalinity is created by being slightly more carbonized and helps relieve gas and cleans the intestinal tract.

Full Carbonization Process: During the full carbonization process, oven temperatures, not to exceed about 500° F. (260° C.), are greatly preferred. It is preferred that the resulting carbonization present a dark brown or black color. Although several methods produced the desired result, a preferred method entails baking the dehydrated product of this present invention as it is still formed as a dehydrated sheet or in the form of flakes or as a combination of both. In the most practical method tested, the dehydrated sheets are placed in a preheated oven with the temperature set at 500° F. The dehydrated product of this present invention is baked for no more than 60 minutes or until the entire top of the dehydrated sheet flakes or a combination of both is deeply carbonized to the desired color.

The full carbonization process effectively increases the product's (before digestion) pH alkalinity level, from acidic (4.5 to 5.5) to that of an alkalizing level (8.0 to 9.0). As an example, in its application as an acid indigestion product, this more neutral alkalizing state creates a product which quickly influences the acid imbalance occurring within the body and brings the desired relief. This extremely high state of alkalinity, created by being fully carbonized, affords certain unique attributes in this product, including the ability to absorb impurities and toxins, relieve gas and clean the intestinal tract.

Industrial ovens, such as those offered by Gruenberg (2121 Reach Road, Williamsport, Pa. 17701), provide professional results by those familiar with the art of carbonization. There is an assortment of industrial ovens available, as either provided by Gruenberg and other industrial oven manufacturers, which are capable of accomplishing the carbonization process.

When using industrial grade ovens, such as those being offered by various industrial oven manufacturers, a variety of product thicknesses, carbonization temperature settings and duration times can be utilized to achieve the same or similar results.

As the technology used in the art of carbonization is improved, other types of carbonization methods may become available to those familiar with the art of carbonization.

Milling:

The product of this present invention, so derived, is then milled to a uniform size, if desired. The milling process for the product of this present invention can be accomplished by a number of different methods, such as a power mill, hammer mill, hammer-cutter mill, cross-beater mill, ball mill or even a hand mill and so on. Although several methods produced the desired result, an example of one of the preferred methods entailed blending a combination of dehydrated sheets, when present, with the dehydrated flakes, when present, into the mill. Prior to this blending, the dehydrated sheets should be cut into strips of about one inch wide. During the milling process, the dehydrated product of this present invention is milled, blended and mixed. This milling will be completed so that the process yields a product which readily flows through a screen mesh size ranging between a 16 and 50, depending on the desired product's application and in such a way that it can easily be formulated into the appropriate embodiment and dosage form. Generally, the 60-80 mesh powder is easily tableted or capsulated using suitable and conventional machinery. The milling process should conclude with the processed dehydrated product of this present invention, in a smoothly blended powder appropriate for the specific embodiment to be used.

As the technology used in the art of milling is improved, other types of milling methods may become available to those familiar with the art of milling and therefore will become available to the inventors in the production of the present invention.

Formulation Process:

The product created by this present invention can now be formulated into unique combinations of the above processes for use in formulating each of the specific products being manufactured as a result of the present invention. Each of the above processes in and of itself has been found to provide a variety of unique and distinctive attributes, including that of medicinal efficacy. Formulations will be made, using the product created from any one of the above processes on its own, or in combination with the product created from more than one of the above processes, to create a variety of product embodiments for use in a wide variety of applications.

In some applications and embodiments, a blend of dehydrated and carbonized product created by this invention will be formulated to provide a particular result. In other applications and embodiments, a blend of more than one carbonized product created by this invention will be formulated so as to provide different results. The product created by this invention can be blended so as to provide a wide assortment of safe medicinal remedies for a wide variety of applications, some known to the inventors, some yet to be discovered.

As an example of these combinations as they may relate to an acid indigestion product, when a lighter potency and absorption rate is required, such as in the case of a child's dosage, or with an elderly individual's dosage, the carbonization process may be lessened or perhaps eliminated altogether, as required to best suit the particular application or embodiment. Conversely, when a severe case of acid indigestion is present, then a blend may consist of non-carbonized dehydrated product, lightly carbonized product and medium carbonized product in an effervescent formula.

In some applications and embodiments, the product as created by this invention as described herein may be formulated in combination with other nutritionally significant compounds for use as a dietary supplement, nutraceutical, or pharmaceutical composition for nutritional, medicinal and/or medical use. Nutraceuticals are foods that have specific medicinal as well as nutritional benefits. The composition may be optionally formulated with a pharmaceutically acceptable carrier therefor and, optionally, other therapeutically active ingredients. The pharmaceutically acceptable carrier, if one is utilized, must be pharmaceutically acceptable in the sense of being compatible with the other ingredients of the formulation and not deleterious to the recipient thereof.

Additives:

Upon the completion of the appropriate formulation process, the product of the present invention is ready for the particular embodiments as required for each unique application.

In the medicine, medicinal remedy or whole food product of the present invention, together with the processed product of this present invention, one or more than two of additives for formulation or food additives can be added. In order to produce solid preparations such as capsules, tablets, strips, suspensions, wipes and powders and so on, the following additives can be used: for example, excipients such as herbal sweeteners, natural flavorings, certified organic flavorings, herbs, certified organic herbs and so on. In the case that the medicine, medicinal remedy or whole food product of the present invention is a liquid preparation, the following additives for medicines can be used: glycerin, filtered or spring water, colorings and so on. In the case that the medicine, medicinal remedies or the whole food product of the present invention requires filler, the following additive will be used: rice powder or certified organic rice powder as appropriate.

Blending Process:

When formulations are to be made using the product of this present invention, as created from more than one of the above processes, or any single process if desired, or if an additive or an excipient has been added to the product's final formulation, the product will be blended. This blending process assures the correct blending of the product formula for a particular or specific embodiment. The blending process for the Ume product can be accomplished by a number of different methods, including drum, double cone, and shell blenders, among others. The blending cycle time is dependent on the type of industrial blender used and the specific product formula to be blended.

There is a wide range of blenders available from a number of industrial blender manufacturers capable of accomplishing the blending process. The preferable mesh size for the blended product of this present invention is dependent on the particular embodiment, whether that is a pill, capsule, powder, suspension, strip or other type of embodiment. Sifting the milled product of this present invention through a 30 to 180 mesh-pass is appropriate for most of the product embodiment applications. A 60 to 80 stainless steel mesh, for example, is the appropriate mesh range for pressed pill applications.

The blending process should conclude with the processed product of this present invention, in a smoothly sifted powder appropriate for the specific embodiment to be used. As the technology used in the art of blending is improved, other types of blending methods may become available to those familiar with the art of blending and therefore will become available to the inventors in the production of the present invention.

Administration:

The phrase “a therapeutically effective amount” means the amount of the composition that provides a therapeutic benefit in the prevention or improvement of the disorders described herein. Although any suitable route of administration may be employed for providing the patient with an effective dosage of the composition according to the methods of the present invention, oral administration is preferred. Suitable routes include, for example, oral, rectal, parenteral, intravenous, topical, transdermal, subcutaneous, intramuscular, and similar forms of administration may also be employed. Suitable dosage forms include tablets, troches, dispersions, suspensions, solutions, capsules, patches, suppositories, and the like, although oral dosage forms are preferred. The formula is preferably provided in the form of capsules, preferably 30 and 120 capsules per bottle, with a shelf life of 3 years. Indications for use are preferably to “take as directed” or one capsule taken twice per day.

The formulations may conveniently be presented in unit dosage form and may be prepared by any of the methods well known in the art of pharmacy, including tablet, capsule and strip, and also as an effervescent in both tablet and in a packaged powder form. All methods include the step of shaping the product into desired unit dosage form or packaging the product into unit dosages, such as capsules. If a carrier is used, such methods also generally include the steps of bringing the active compound into association with a carrier and one or more optional accessory ingredients. In general, the formulations are prepared by uniformly and intimately bringing the active compound into association with a liquid or solid carrier and then shaping or packaging into discrete unit dosages.

Formulations of the present invention suitable for oral administration may be presented as discrete units such as capsules, cachets, tablets, strips, boluses or lozenges, each containing a predetermined amount of the product as a powder or granules or small fibers.

Tablet: The present invention in its tablet embodiment can either be chewed and then swallowed or swallowed whole with water. When chewed, the absorption into the consumer's bloodstream is extremely quick with almost instantaneous results as a hiccup medicine or remedy and quick results as an acid indigestion medicine or remedy. When swallowed whole with water, the absorption in the stomach has fairly quick results as a hiccup medicine or remedy and quick results as an acid indigestion medicine or remedy. The product created by this present invention introduces a concentrated alkaline forming whole food into the digestive system and the blood stream, thereby establishing the optimal pH balance required to relieve the condition.

As for the tablets mentioned above, it does not matter if they are sustained release tablets, coated tablets such as sugar-coated, enteric coated or film-coated ones, or masked ones. Further, it does not matter if the medicine, medicinal remedy or the processed whole food product of the processed product of the present invention is of the liquid preparation such as solutions, suspensions, syrups or elixirs and so on available on the market. Such medicine, medicinal remedies or the processed whole food product of the present invention can be manufactured according to accepted or common methods used in the field and manufacturing of medicines, medicinal remedies or in the field of foods.

In order to produce solid preparations such as capsules, tablets, powders, or granules and so on, the following additives can be used: for example, excipients such as lactose, glucose, sucrose, mannitol, and so on; disintegrators such as starch, sodium arginate, and so on; lubricants such as magnesium stearate, talc, and so on; binders such as polyvinyl alcohol, hydroxypropylcellulose, gelatin, and so on; surfactants such as fatty acid esters, and so on; plasticizers such as glycerin and so on. In the case that the medicine of the present invention is a liquid preparation, the following additives for medicines can be used: for example, water, filtered water, spring water, and so on; saccharides such as sucrose, sorbitol, fructose, and so on; glycols such as polyethylene glycol, propylene glycol, and so on; oils such as sesame oil, olive oil, soybean oil, and so on; antiseptics such as p-hydroxybenzoic esters, and so on. Further, the capsular preparations can easily be produced by filling the commonly used capsules for medicines and medicinal remedies with powders or granules.

Capsule: The present invention in its capsule embodiment can be swallowed whole with water. When swallowed whole with water, the absorption in the stomach is extremely quick and offers extremely quick results as an acid indigestion medicine or remedy. The product created by this present invention introduces a concentrated alkaline forming whole food into the digestive system and the blood stream, thereby establishing the optimal pH balance required to relieve the condition.

Strip: The present invention in its strip embodiment is placed on the tongue where it melts into a liquid and is digested. The absorption is instantaneous and offers instantaneous results as a hiccup medicine or remedy. The product created by this present invention introduces a concentrated alkaline forming whole food into the digestive system and the blood stream, thereby establishing the optimal pH balance required to relieve the condition.

Package Powder of Effervescent: The present invention, in its packaged powder effervescent embodiment, has been designed to be poured into a glass of fluid, e.g., water, and after the effervescent effect has been completed, be swallowed. Once swallowed, absorption within the stomach is almost instantaneous, thereby providing an immediate relief to the acid indigestion condition.

Effervescent Tablet: The present invention, in its tablet effervescent embodiment, has been designed to be dropped into a glass of water and after the effervescent effect has been completed, be swallowed. Once swallowed, absorption within the stomach is almost instantaneous, thereby providing an immediate relief to the acid indigestion condition.

The embodiments for both the package powder and effervescent tablet have been configured and tested using two commonly available bicarbonates, including potassium and sodium. In order to add an effervescent action to a particular product, typically, a manufacturer will blend sodium or potassium bicarbonate with a corresponding amount of citric acid which, when placed together into water, establish the desired effervescent action. The acids, such as citric, malic, succinic and tartaric, amongst others, which are contained naturally within the Ume, create a desirable effervescent reaction with either of the bicarbonates. Therefore, less citric acid is needed than would normally be required to generate the required effervescing effect. The preferred bicarbonate is potassium bicarbonate, but as an alternative to those applications where potassium is not recommended, such as in the case of an allergy, a sodium bicarbonate embodiment will be made available. The product created by this present invention is substantially different from any product previously available on the market in that i) it offers an immediate pH neutralizing alkaline through the introduction of the effervescing potassium bicarbonate, and ii) it provides a sustaining pH neutralizing alkaline through the introduction of the concentrated alkaline-forming whole food into the digestive system and the blood stream which, when offered in this combination for the first time; establishes an optimal balance between immediate and sustaining pH relief for all forms of acid indigestion, including acid reflux.

In the case of the effervescent, whether in tablet or powder form, potassium bicarbonate was added to create the effervescent effect. The potassium bicarbonate has a natural reaction to the acids, such as citric, malic, succinic and tartaric, amongst others, present within the pickled Ume and creates the effervescent effect. As tested, the formulation included an appropriate amount of sodium bicarbonate and was dropped into a ½ cup of water. During the initial testing of this embodiment, the potassium bicarbonate established a diluted pH of between 7.0-7.25, which represented a significant improvement in pre-ingested pH over the current over-the-counter acid indigestion remedies. A pH level of 7.0 is considered optimal pH balance of acid and alkaline. 7.25 is ever so slightly alkaline but is still considered to be within the optimum range. When configured as an effervescent, the invention provided immediate relief of common acid indigestion, heartburn, sour stomach, upset stomach, gas, diarrhea, and even acid reflux. In some applications and embodiments, the present invention may prove to have a diluted pH level other than that as described above.

The medicine, medicinal remedy or whole food product of the present invention is effective for prevention of or treatment for various ailments and is a medicine or medicinal remedy for blood cleansing, restoring optimum blood flow, liver cleansing, reducing excess cholesterol, increasing vitality and strength, anti-aging, stimulating metabolism to build the immune system and building resistance to disease, and as such has been proven to be effective as a treatment for stomatitis, dysentery, typhoid, hypertension in children, headache pain, common cold, common flu, motion sickness, second degree burns, hangovers, ptomaine poisoning, food poisoning, hemorrhoids, vaginitis, vertigo, anemia, eczema, athlete's foot, halitosis, nasal conditions, colic in infants, lack of appetite, vomiting during pregnancy, as a laxative, an enema, as an edible disinfectant for applications in food cleansing, and as a natural food preservative.

The amount of the composition required to be effective for promoting and maintaining sound health will, of course, vary with the material used in the formulation of the composition and the individual mammal being treated and is ultimately at the discretion of the individual or medical or veterinary practitioner.

In general, the pharmaceutical compositions of this invention contain from about 50 to about 5000 mg of powder, and preferably from about 250 to about 1000 mg of powder, preferably in a unit dosage form. The recommended dosage of powder is 1000 mg a day, preferably in a single dose, which has been determined by laboratory analysis and confirmed by case studies.

Case Studies

Case Study 1—Female; Age 46, Weight; 110 lbs.

The individual experienced an extreme case of acid indigestion, which had persisted for longer than three hours and manifested into intense pain in the lower abdominal tract. This individual tried using TUMS brand antacid within a half hour of the symptom, with no sign of relief. At about one hour into the pain, ALKA-SELTZER brand antacid was tried but also failed to relieve the symptom. Three hours into the pain, she was prepared to go to emergency room at a local hospital but instead was given a dosage of the UME product of the present invention. The dosage was two 500 mg capsules of the product which consisted of a blend of 50% dehydrated, 25% light carbonized and 25% medium carbonized product. This individual reported complete relief of pain she had experienced in the lower abdominal tract, along with all other symptoms of acid indigestion, within ten minutes of taking the product. Since this experience, this individual has used the product created by this invention on many occasions to relieve acid indigestion, with relief being reported on every instance.

Case Study 2—Female; Age 48 Weight; 116 lbs.

The individual experienced acid indigestion, which included symptoms of stomach bloating, pain and gas. She was given a dosage of the product of the present invention. A dosage of two 500 mg capsules of the product which consisted of a blend of 50% dehydrated and 50% light carbonized product. This individual reported complete relief of pain she had experienced in her stomach, along with her symptoms of gas, within three minutes of taking the product. This individual has used the product created by this invention on several occasions to relieve acid indigestion since this first incident, with relief being reported on every instance.

Case Study 3—Female; Age 50 Weight; 111 lbs.

The individual experienced light acid indigestion which was caused by eating acid foods. This female was given a dosage of one 500 mg capsule of the product of the present invention, which in this case consisted of a blend of 100% dehydrated product. This individual reported complete relief of this light acid indigestion within two minutes of taking the product. This individual has since used the product created by this invention on a daily basis as a dietary supplement, with no known cases of acid indigestion occurring since then.

Case Study 4—Male, Age 25, Weight; 230 lbs.

This individual constantly eats foods that are acid forming and experiences acid indigestion on a regular basis, which included symptoms such as upset stomach, diarrhea, gas and, on some occasions, severe acid reflux. He was given two separate dosage routines to use, dependent upon the acid indigestion symptoms being experienced at the time of the occurrence. Both dosages were of the product of the present invention. One dosage recommendation was for two 500 mg capsules of the product which consisted of a blend of 50% dehydrated and 50% medium carbonized product, for use in all applications except that of acid reflux. The second dosage recommendation was for the effervescent product which included a 1000 mg blend of 50% dehydrated and 50% medium carbonized product, for use in all occurrences of acid reflux. This individual has used the two products created by this invention on several occasions to relieve acid indigestion, including that of acid reflux, on every instance, with complete relief being reported on each occasion.

Case Study 5—Male, Age 54, Weight; 205 lbs.

This individual periodically eats high processed foods which are acid forming and acid foods. He experiences acid indigestion which manifests itself with symptoms which include belching, burping and flatulence. This individual was given a dosage recommendation for the product of the present invention. The recommended dosage of two 500 mg capsules of the product which consisted of a blend of 50% dehydrated and 50% light carbonized product. This individual reported complete relief of gas being generated to cause the acid indigestion symptoms, typically within three minutes of taking the product. This individual has used the product created by this invention on many occasions, with relief being reported on every instance.

Case Study 6—Male, Age 9, Weighing 58 lbs.

The child experienced lower digestive stomach aches caused presumably by overly processed foods and sugared foods and drinks. This child was given a dosage recommendation of the product of the present invention, which in this case was for one 500 mg chewable tablet which consisted of 100% dehydrated product. This individual's parent reported complete relief of the child's acid indigestion within four minutes of taking the product. This individual has since used the product created by this invention on a regular basis, when cases of acid indigestion occurred since then.

Case Study 7—Female, Age 40, Weighing 121 lbs.

The individual experiences heartburn in the upper chest cavity area, especially when eating highly processed and spicy foods. Because she is against taking drugs, typically this individual does not take any over-the-counter acid indigestion drugs or remedies for her acid indigestion and instead allows the heartburn to go through its natural process until the pain disappears. This individual was given a dosage recommendation for the product of the present invention. The recommended dosage of two 500 mg tablets of the product which consisted of a blend of 50% dehydrated and 50% light carbonized product. This individual reported complete relief of heartburn caused by the acid indigestion, typically within three minutes of taking the product. This individual has used the product on many occasions with complete relief being reported each time.

Case Study 8—Female, Age 35, Weighing 137 lbs.

The individual experiences severe acid reflux for which she has been using the over-the-counter version of PRILOSEC brand antacid for more than three years. Concern about taking drugs caused this individual to request a dosage recommendation for the product of the present invention. A recommended dosage of two 500 mg tablets of the product, which consisted of a blend of 50% dehydrated and 50% medium carbonized product to be taken at the first sign of acid indigestion, was made. This individual reported complete acid indigestion relief, and presumably the prevention of ensuing acid reflux, within a few minutes of taking the product. This individual has used the product on a regular basis with complete relief being reported each time.

Case Study 9—Male, Age 28, Weighing 185 lbs.

This individual for a number of years has consistently suffered cramps in the lower abdominal tract, along with a sour stomach after eating a combination of pizza and beer. He was given a dosage recommendation for the product of the present invention. The dosage was for two 500 mg capsules of the product which consisted of a blend of 50% dehydrated, 25% light carbonized and 25% medium carbonized product. This individual reported complete relief of the pain he had experienced in the lower abdominal tract along with all other symptoms of acid indigestion, typically within five minutes of taking the product. This individual has used the product created by this invention on many occasions to relieve acid indigestion, with relief being reported on every instance.

Case Study 10—Male, Age 32, Weighing 171 lbs.

This individual frequently enjoys eating highly spicy foods, including pizza, and drinking beer late at night and, as such, experiences severe acid reflux once in bed. He has been a long-time TUMS brand antacid user but, for the most part, is not satisfied with the number of tablets he must consume to achieve results. He was given two separate dosage routines to use, dependent upon the acid indigestion symptoms being experienced at the time of the occurrence. Both dosages were of the product of the present invention. One dosage recommendation was for two 500 mg capsules of the product which consisted of a blend of 50% dehydrated and 50% medium carbonized product, for use in all applications except that of acid reflex, to be taken at the first sign of an acid indigestion condition. The second dosage recommendation was for the effervescent product which included a 1000 mg blend of 50% dehydrated and 50% medium carbonized product, for use in all occurrences of acid reflex. This individual has used the first product created by this invention on several occasions to relieve acid indigestion which ultimately proved to prevent the occurrence of acid reflux, with complete relief being reported on each occasion.

Case Study 11—Male, Age 55, Weighing 198 lbs.

This individual had been suffering with both stomach ulcers and acid reflux rather consistently for the past 26 years. Although he enjoys spicy Mexican and Italian cuisine, his digestive system reacts harshly to these foods. As prescribed by a medical doctor, this individual has been a long-time user of the prescription and over-the-counter PROTON pump inhibitors and H2 BLOCKERS acid reflux drugs. Twice a year, in the spring and again in the fall, he generally experiences a worsening acid indigestion condition. Suffering with major gastric attacks during these times requires a very aggressive regiment of TAGAMET brand antacid, which he takes for up to 10 days, with dosages up to 1000 mgs, at least 3 times per day in order to keep his acid production under control. Unfortunately, the drug brought on a side effect which did nothing but further worsen his condition. His doctor had confirmed that he had developed a severe case of helicobacter bacteria in his digestive system. This individual desired a lifestyle and diet change and wanted to eliminate his dependency on the TAGAMET product. He was given a dosage recommendation for the product of the present invention. The first step he executed of his own accord was a colon cleansing that took two days over a weekend. Upon completion, he also began an aggressive strategy of taking two 500 mg capsules of the product which consisted of a blend of 50% dehydrated, 25% light carbonized and 25% medium carbonized product, three times a day for a full week. He was able to control his acid indigestion completely, without the use of the TAGAMET product or any other over-the-counter antacids. After the completion of a week, he attacked this bacteria again with a second colon cleansing while still maintaining the 500 mg dosage of three times per day of the product of this invention. Following this second cleansing, he reduced his dosage of the product to just one 500 mg capsule, three times per day for the next two weeks. By the third week, he reduced his daily dosage of the product again to only one 500 mg capsule per day for an additional two weeks. After five weeks of using the product of this invention, he reached a position with his acid indigestion that he no longer needed to take the product at all. In fact, he went three full weeks without taking the product and was capable of eating spicy Mexican and Italian food without any return of acid indigestion. This individual reports that he has never felt better or had more energy than he experiences today. He is convinced that the product produced by this invention, along with the colon cleansing, totally relieved his severe case of helicobacter bacteria and his long-time acid indigestion condition. He keeps a supply of the inventor's product with him at all times and is ready in the event he should suffer with an acid indigestion situation.

Case Study 12—Female, Age 60 Weighing 107 lbs.

This individual is an avid jogger and typically jogs 32 miles per week. She is careful what she eats and still suffers with acid reflux on a continuous basis. Every night for the last 20 years she sleeps with two pillows under her head in order to keep her head propped up. When the pain becomes too severe, she takes two capsules of a generic brand of ibuprofen to relieve the symptom of pain, which usually gets her through the night. She was given a dosage recommendation for the product of the present invention. The dosage was for two 500 mg capsules of the product which consisted of a blend of 50% dehydrated, 25% light carbonized and 25% medium carbonized product. This individual reported complete relief of the acid indigestion, typically within five minutes of taking the product. This individual has used the product created by this invention on many occasions to relieve acid indigestion, with relief being reported on every instance and now sleeps with a single pillow.

Case Study 13—Female, Age 57, Weighing 143 lbs.

This individual is a single mother who has chronic indigestion condition which may be linked to the consumption of alcoholic beverages. In the past, she has relied on TUMS product. She was given a dosage recommendation of the product of the present invention, which in this case was for one 500 mg chewable tablet which consisted of 100% dehydrated product. She has since reported complete relief of the acid indigestion within four minutes of taking the product. This individual has since used the product created by this invention on a regular basis, when cases of acid indigestion occurred since then, each time with positive results.

Case Study 14—Female, Age 53, Weighing 108 lbs.

This individual eats very hot, spicy foods and on occasion experiences excruciating burning within the small intestines. She was given a dosage recommendation of the product of the present invention, which in this case was for two 500 mg capsules of the product of this invention, which consisted of a blend of 50% dehydrated and 50% light carbonized product. Her burning sensation was calmed in approximately five minutes. Another two capsules of the product were taken one hour later. Her symptoms were completely relieved. With the knowledge that she has learned from this invention, she keeps them on hand at all times.

Case Study 15—Male, Age 34, Weighing 152 lbs

The individual suffers with acid indigestion only once in a while for which discomfort and cramping are in the lower abdomen region. His choice for an over-the-counter product in the past was the TUMS product. He was given a dosage recommendation for the product of the present invention. The dosage was for two 500 mg chewable tablets, which consisted of a blend of 50% dehydrated and 50% medium carbonized, and he felt immediate relief of his cramps and also noted that he had extra energy.

Case Study 16—Female, Age 55, Weighing 112 lbs.

This individual frequently eats spicy dishes which include sausage in combination with many herbs and spices. She commonly experiences discomfort in the lower abdominal region. She also complains of having a reoccurring lower back problem, apparently due to kidney stagnation. She was given a dosage recommendation for the product of the present invention. The dosage was for two 500 mg capsules which consisted of 100% dehydrated product, which she takes after every meal. Within a 30 day period, her dosage was reduced to one 500 mg capsule to be taken after meals. Her lower abdominal discomfort and her chronic lower back pain have ceased.

Case Study 17—Male, Age 8, Weighing 46 lbs.

This child experiences hiccups on at least a monthly basis. The child was given a dosage recommendation for the product of the present invention. The dosage was for one strip, which consisted of 250 mg of 100% dehydrated product. Shortly after the product of this invention was placed onto the child's tongue, his hiccups stopped.

Case Study 18—Male, Age 21, Weighing 180 lbs.

This individual drinks several beers well into the evening hours, and when he combines the beer with an acid forming food such as spicy hot chicken wings or pizza, he experiences hiccups. He was given a dosage recommendation for the product of the present invention. The dosage was for one strip, which consisted of 250 mg of 50% dehydrated and 50% light carbonized product. Within ten seconds of the product of this invention being placed onto this individual's tongue, his hiccups ceased.

Case Study 19—Female, Age 27, Weighing 98 lbs.

This individual has periodic episodes of hiccups when she is outside and takes in a gasp of air. Nothing in the past has relieved her hiccupping except for time. She was given a dosage recommendation for the product of the present invention. The dosage was for one strip, which consisted of 250 mg of 50% dehydrated and 50% light carbonized product. She has indicated that within a few seconds of taking the product of this invention, her hiccups ceased.

Case Study 20—Male, Age 3 Months, Weighing 18 lbs

The infant was taken off of breast milk and introduced to infant formula and subsequently became colicky. The infant was given a dosage recommendation for the product of the present invention. The dosage was for approximately 50 mg of 100% dehydrated product mixed in with 4 fluid ounces of distilled water and was bottle fed to the infant, of which the infant ingested approximately two fluid ounces. Within five minutes, the infant released several series of flatulence and was calmed. Anytime the baby displayed colic, the same formula was given, having the same results as the first; until he was introduced to milk one year later.

Case Study 21—Female, Age 28, Weighing 107 lbs

This individual is a first-time mother and was in her 20th day into pregnancy. She experienced bouts of “morning sickness” or vomiting several times per day and had difficulty keeping anything down. She was given a dosage recommendation for the product of the present invention. The dosage was for two 500 mg capsules which consisted of 50% dehydrated and 50% light carbonized product. She has indicated that within five minutes of taking the product of this invention, her nausea, along with her need to vomit, had ceased. Anytime during the nine month pregnancy, if she felt nausea, she would repeat the same dosage and achieved similar results.

It is understood that the invention is not confined to the particular construction and arrangement of parts herein illustrated and described, but embraces such modified forms thereof as come within the scope of the following claims.

What is claimed is:

1. A method of producing a therapeutic supplement from Ume fruit, in the absence of the Ume seed, wherein the Ume fruit is obtained from the Prunus Mume Sieb, et Zucc., comprising:
a. removing the seeds from the Ume fruit;
b. macerating the Ume fruit to form a Ume paste; and
c. dehydrating the Ume paste.

2. The method of claim 1 further comprising carbonizing the dehydrated Ume paste of step c.

3. The method of claim 2 wherein the dehydrated Ume paste is carbonized to a pH alkalinity level between approximately 7.0 and 9.0.

4. The method of claim 2 wherein the dehydrated Ume paste is carbonized to a pH alkalinity level between approximately 7.0 and 7.25.

5. The method of claim 2 wherein the dehydrated Ume paste is carbonized to a pH alkalinity level between approximately 7.25 and 8.0.

6. The method of claim 2 wherein the dehydrated Ume paste is carbonized to a pH alkalinity level between approximately 8.0 and 9.0.

7. The method of claim 2 wherein the dehydrated Ume paste is carbonized at temperatures not exceeding about 400° F. for a period no more than about 60 minutes.

8. The method of claim 2 wherein the dehydrated Ume paste is carbonized at temperatures not exceeding about 500° F. for a period no more than about 40 minutes.

9. The method of claim 2 wherein the dehydrated Ume paste is carbonized at temperatures not exceeding about 500° F. for a period no more than about 60 minutes.

10. The method of claim 1 wherein the Ume paste is dehydrated to a moisture content no more than about 6% by weight.

11. The method of claim 1 wherein the Ume paste is dehydrated to a moisture content between about 2% and about 4% by weight.

12. The method of claim 1 wherein the Ume fruit is a pickled Ume fruit.

13. The method of claim 1 wherein the Ume fruit consists of the exodermis, and the sarcocarp.

14. The method of claim 1 further comprising milling the product.

15. The method of claim 14 wherein product is milled to a mesh size of between about 30 and about 80.

16. The method of claim 14 wherein product is milled to a mesh size of between about 60 and about 80.

17. A therapeutic supplement produced according to the method of claim 1.

18. A therapeutic supplement comprising a therapeutically effective amount of processed Ume fruit in the absence of the Ume seed, wherein the Ume fruit is obtained from the Prunus Mume Sieb, et Zucc., in combination with a pharmaceutically-acceptable carrier, wherein the therapeutically effective amount of Ume fruit is effective to treat an animal.

19. The therapeutic supplement of claim 18, wherein the processed Ume fruit has a pH level between about 7.0 and 9.0.

20. The therapeutic supplement of claim 18, wherein the processed Ume fruit has a pH level between about 7.25 and 8.0.

21. The therapeutic supplement of claim 18, wherein the pharmaceutically-acceptable carrier is present in the form of capsules, tablets, strips, suspensions, wipes, powders and effervescent powders and tablets.

22. The therapeutic supplement of claim 18, further comprising one or more excipients selected from the group consisting of herbal sweeteners, natural flavorings and herbs.

23. The therapeutic supplement of claim 18, further comprising additives selected from the group consisting of glycerin, filtered or spring water, and colorings, fillers, binders including polyvinyl alcohol, hydroxypropylcellulose, and gelatin, lactose, glucose, sucrose, mannitol, starch, sodium arginate, magnesium stearate, talc, surfactants including fatty acid esters, plasticizers including glycerin, saccharides including sucrose, sorbitol, and fructose, glycols including polyethylene glycol, and propylene glycol, oils including sesame oil, olive oil, and soybean oil, antiseptics including p-hydroxybenzoic esters.

24. The therapeutic supplement of claim 18, wherein the therapeutically effective amount of Ume fruit in the absence of the Ume seed, is effective to treat and prevent acid indigestion, heartburn, sour stomach, upset stomach, gas, diarrhea, acid reflux, stomatitis, dysentery, typhoid, hypertension in children, headache pain, common cold, common flu, motion sickness, second degree burns, hangovers, ptomaine poisoning, food poisoning, hemorrhoids, vaginitis, vertigo, anemia, eczema, athlete's foot, bad breath, halitosis, nasal conditions, colic in infants, lack of appetite, and vomiting during pregnancy.

25. The therapeutic supplement of claim 18, wherein the therapeutically effective amount of Ume fruit in the absence of the Ume seed, is effective as an edible disinfectant for applications in food cleansing and as a natural food preservative.

26. The therapeutic supplement of claim 18, wherein the therapeutically effective amount of Ume fruit in the absence of the Ume seed, is between about 50 to about 5000 mg of powder in a unit dosage form.

27. The therapeutic supplement of claim 18, wherein the effective amount of the therapeutically effective amount of Ume fruit in the absence of the Ume seed, is from about 250 to about 1000 mg of powder in a unit dosage form.

28. A therapeutic supplement for the relief of acid indigestion or hiccups comprising a therapeutically effective amount of processed Ume fruit in the absence of the Ume seed, wherein the processed Ume fruit is obtained from the Prunus Mume Sieb, et Zucc., in combination with a pharmaceutically-acceptable carrier, wherein the therapeutically effective amount of processed Ume fruit is effective to treat acid indigestion or hiccups in an animal, wherein the processed Ume fruit has a pH level between about 7.0 and 9.0.

29. The therapeutic supplement of claim 28 further comprising additives selected from the group consisting of glycerin, filtered or spring water, and colorings, fillers, binders including polyvinyl alcohol, hydroxypropylcellulose, and gelatin, lactose, glucose, sucrose, mannitol, starch, sodium arginate, magnesium stearate, talc, surfactants including fatty acid esters, plasticizers including glycerin, saccharides including sucrose, sorbitol, and fructose, glycols including polyethylene glycol, and propylene glycol, oils including sesame oil, olive oil, and soybean oil, antiseptics including p-hydroxybenzoic esters.

30. The therapeutic supplement of claim 28, wherein the pharmaceutically-acceptable carrier is present in the form of capsules, tablets, strips, suspensions, wipes, powders and effervescent powders and tablets.

31. The therapeutic supplement of claim 28, further comprising one or more excipients selected from the group consisting of herbal sweeteners, natural flavorings and herbs.

32. The therapeutic supplement of claim 28, wherein the effective amount of the therapeutically effective amount of Ume fruit in the absence of the Ume seed, is from about 50 to about 5000 mg of powder in a unit dosage form.

33. The therapeutic supplement of claim 28, wherein the effective amount of the therapeutically effective amount of Ume fruit in the absence of the Ume seed, is from about 250 to about 1000 mg of powder in a unit dosage form.
